(19) United States
(12) Patent Application Publication
(10) Pub. No.: US 2023/0403616 A1
(43) Pub. Date: Dec. 14, 2023

(54) CONDITIONAL HANDOVER CONDITIONS ASSOCIATED WITH A HEIGHT OF A USER EQUIPMENT

(71) Applicant: QUALCOMM Incorporated, San Diego, CA (US)

(72) Inventors: Chiranjib SAHA, San Diego, CA (US); Umesh PHUYAL, San Diego, CA (US); Le LIU, San Jose, CA (US); Alberto RICO ALVARINO, San Diego, CA (US); Xiao Feng WANG, San Diego, CA (US); Changhwan PARK, San Diego, CA (US); Masato KITAZOE, Tokyo (JP); Bharat SHRESTHA, San Diego, CA (US); Wanshi CHEN, San Diego, CA (US)

(21) Appl. No.: 17/806,926

(22) Filed: Jun. 14, 2022

(51) Int. Cl. H04W 36/00; H04W 36/32

(52) U.S. Cl. CPC H04W 36/00837; H04W 36/0058; H04W 36/00835; H04W 36/32

(57) ABSTRACT

Various aspects of the present disclosure generally relate to wireless communication. In some aspects, a user equipment (UE) may receive a configuration of one or more conditional handover conditions associated with one or more candidate cells, wherein each of the one or more conditional handover conditions is based at least in part on a height of the UE. The UE may trigger a conditional handover procedure based at least in part on the height of the UE. Numerous other aspects are described.

### FIELD OF THE DISCLOSURE

Aspects of the present disclosure generally relate to wireless communication and to techniques and apparatuses for conditional handover conditions associated with a height of a user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of one or more conditional handover conditions associated with one or more candidate cells, wherein each of the one or more conditional handover conditions is based at least in part on a height of the UE. The method may include triggering a conditional handover procedure based at least in part on the height of the UE.

Some aspects described herein relate to a method of wireless communication performed by a network node. The method may include transmitting, to a UE, a configuration of one or more conditional handover conditions associated with one or more candidate cells, wherein each of the one or more conditional handover conditions is based at least in part on a height of the UE. The method may include receiving, from another network node associated with a candidate cell of the one or more candidate cells, an indication that a conditional handover procedure was performed between the UE and the other network node, wherein the conditional handover procedure is triggered based at least in part on the height of the UE.

Some aspects described herein relate to an apparatus for wireless communication at a UE. The apparatus may include a memory and one or more processors coupled to the memory. The one or more processors may be configured to receive a configuration of one or more conditional handover conditions associated with one or more candidate cells, wherein each of the one or more conditional handover conditions is based at least in part on a height of the UE. The one or more processors may be configured to trigger a conditional handover procedure based at least in part on the height of the UE.

Some aspects described herein relate to an apparatus for wireless communication at a network node. The apparatus may include a memory and one or more processors coupled to the memory. The one or more processors may be configured to transmit, to a UE, a configuration of one or more conditional handover conditions associated with one or more candidate cells, wherein each of the one or more conditional handover conditions is based at least in part on a height of the UE. The one or more processors may be configured to receive, from another network node associated with a candidate cell of the one or more candidate cells, an indication that a conditional handover procedure was performed between the UE and the other network node, wherein the conditional handover procedure is triggered based at least in part on the height of the UE.

Some aspects described herein relate to a non-transitory computer-readable medium that stores a set of instructions for wireless communication by a UE. The set of instructions, when executed by one or more processors of the UE, may cause the UE to receive a configuration of one or more conditional handover conditions associated with one or more candidate cells, wherein each of the one or more conditional handover conditions is based at least in part on a height of the UE. The set of instructions, when executed by one or more processors of the UE, may cause the UE to trigger a conditional handover procedure based at least in part on the height of the UE.

Some aspects described herein relate to a non-transitory computer-readable medium that stores a set of instructions for wireless communication by a network node. The set of instructions, when executed by one or more processors of the network node, may cause the network node to transmit, to a UE, a configuration of one or more conditional handover conditions associated with one or more candidate cells, wherein each of the one or more conditional handover conditions is based at least in part on a height of the UE. The set of instructions, when executed by one or more processors of the network node, may cause the network node to receive, from another network node associated with a candidate cell of the one or more candidate cells, an indication that a conditional handover procedure was performed between the UE and the other network node, wherein the conditional handover procedure is triggered based at least in part on the height of the UE.

Some aspects described herein relate to an apparatus for wireless communication. The apparatus may include means for receiving a configuration of one or more conditional handover conditions associated with one or more candidate cells, wherein each of the one or more conditional handover conditions is based at least in part on a height of the apparatus. The apparatus may include means for triggering a conditional handover procedure based at least in part on the height of the apparatus.

Some aspects described herein relate to an apparatus for wireless communication. The apparatus may include means for transmitting, to a UE, a configuration of one or more conditional handover conditions associated with one or more candidate cells, wherein each of the one or more conditional handover conditions is based at least in part on a height of the UE. The apparatus may include means for receiving, from a network node associated with a candidate cell of the one or more candidate cells, an indication that a conditional handover procedure was performed between the UE and the network node, wherein the conditional handover procedure is triggered based at least in part on the height of the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a handover procedure, in accordance with the present disclosure.

FIG. 5 is a diagram illustrating an example of a conditional handover procedure, in accordance with the present disclosure.

FIG. 6 is a diagram of an example associated with conditional handover conditions associated with a height of a UE, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

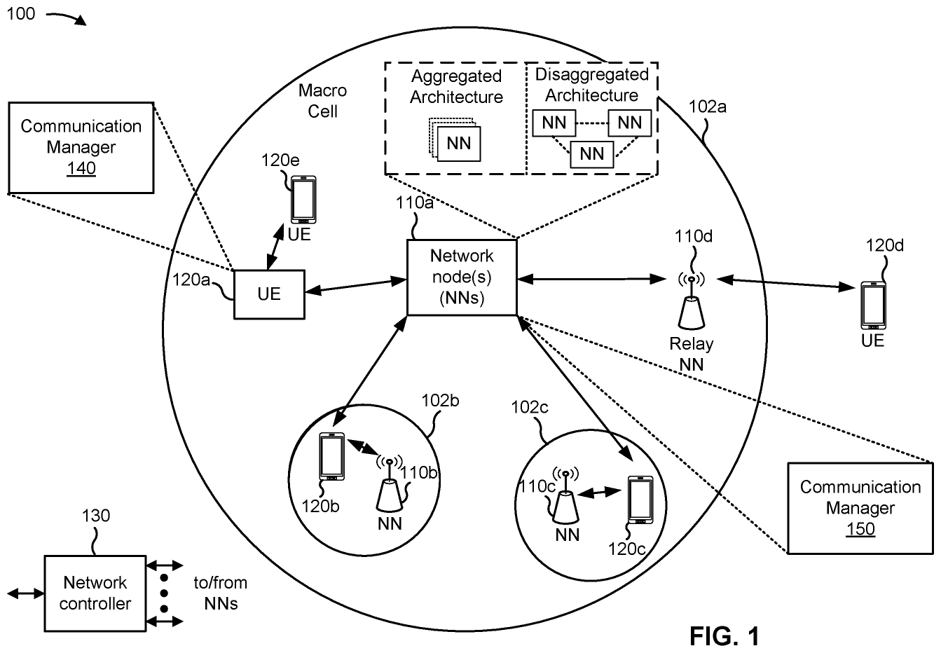

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of one or more conditional handover conditions associated with one or more candidate cells, wherein each of the one or more conditional handover conditions is based at least in part on a height of the UE 120; and trigger a conditional handover procedure based at least in part on the height of the UE 120. Additionally, or alternatively, the communication manager 140 may perform one or more other operations described herein.

In some aspects, the network node 110 may include a communication manager 150. As described in more detail elsewhere herein, the communication manager 150 may transmit, to a UE (e.g., UE 120), a configuration of one or more conditional handover conditions associated with one or more candidate cells, wherein each of the one or more conditional handover conditions is based at least in part on a height of the UE; and receive, from another network node associated with a candidate cell of the one or more candidate cells, an indication that a conditional handover procedure was performed between the UE and the other network node, wherein the conditional handover procedure is triggered based at least in part on the height of the UE. Additionally, or alternatively, the communication manager 150 may perform one or more other operations described herein.

As indicated above, FIG. 1 is provided as an example. Other examples may differ from what is described with regard to FIG. 1.

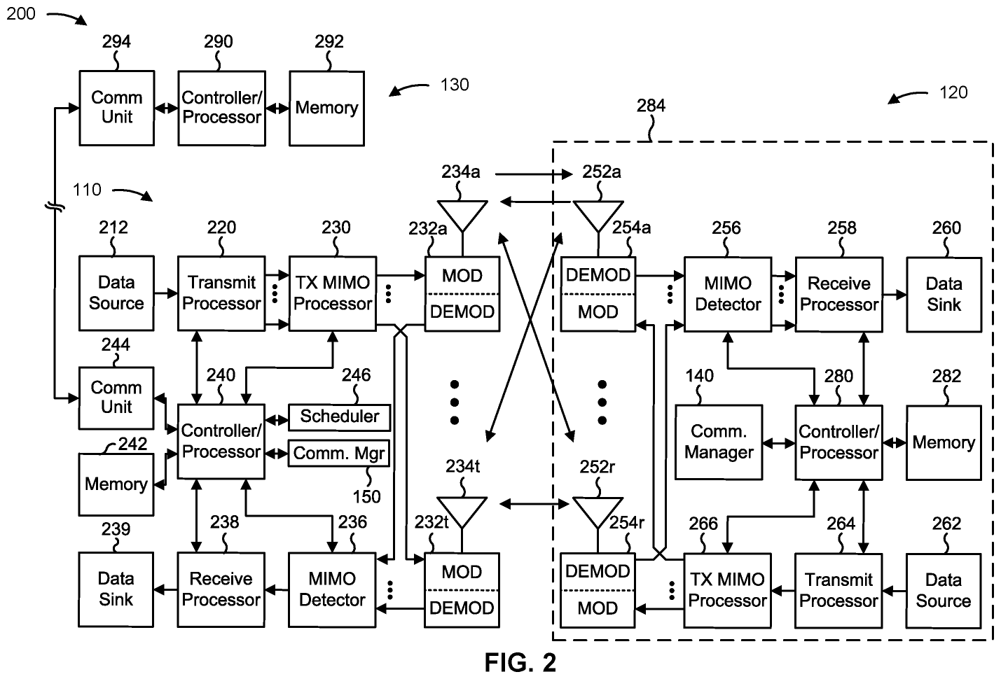

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

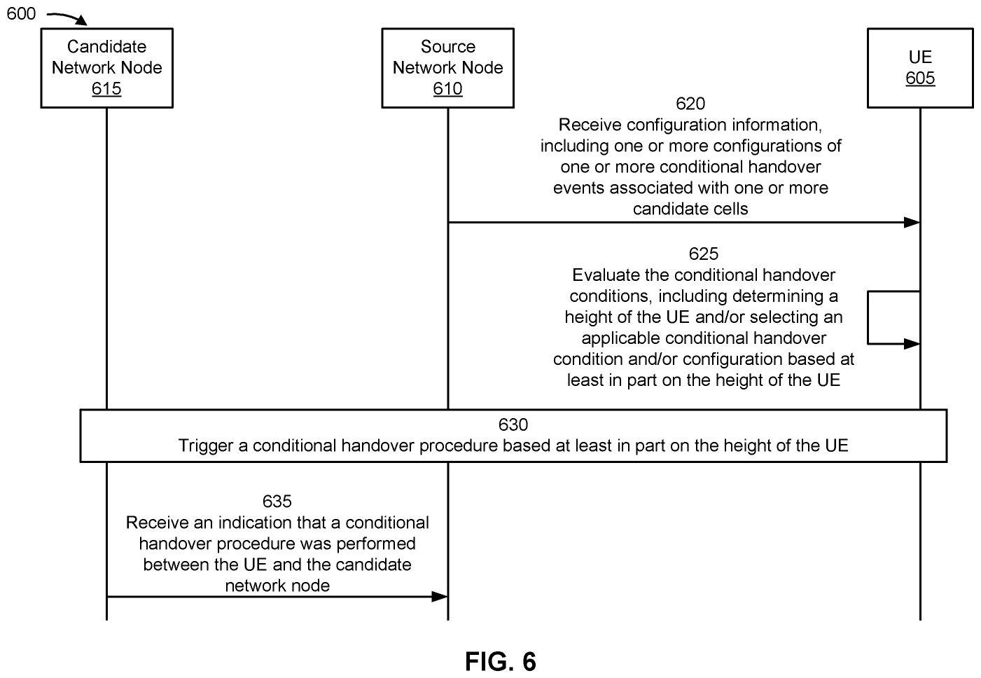

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

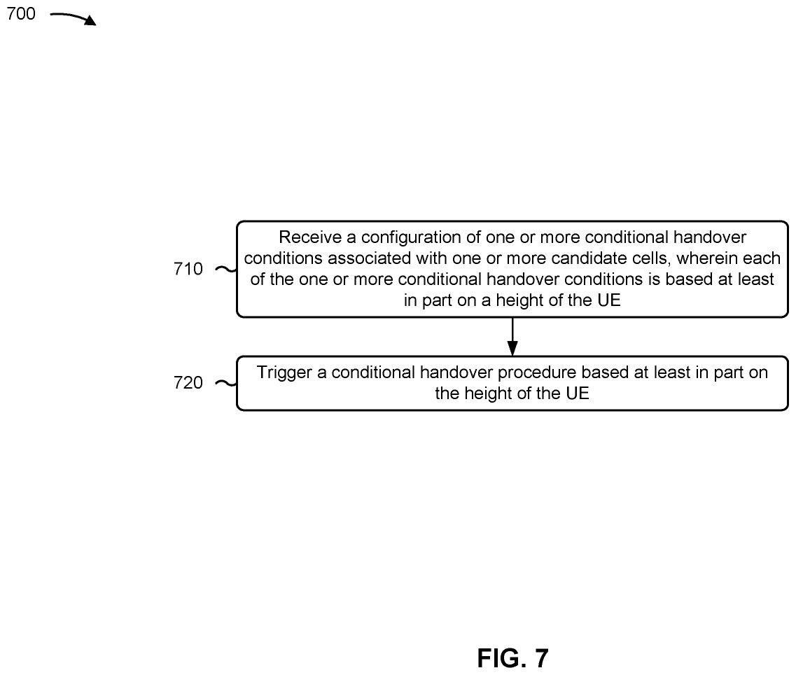

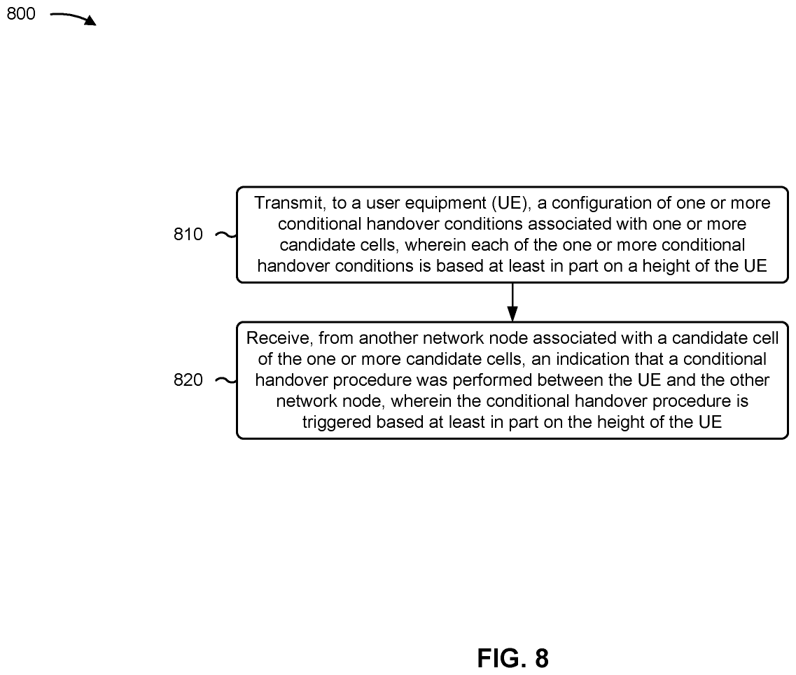

The controller/processor 240 of the network node 110, the controller/processor 280 of the UE 120, and/or any other component(s) of FIG. 2 may perform one or more techniques associated with conditional handover conditions associated with a height of a UE, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration of one or more conditional handover conditions associated with one or more candidate cells, wherein each of the one or more conditional handover conditions is based at least in part on a height of the UE 120; and/or means for triggering a conditional handover procedure based at least in part on the height of the UE 120. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a configuration of one or more conditional handover conditions associated with one or more candidate cells, wherein each of the one or more conditional handover conditions is based at least in part on a height of the UE 120; and/or means for receiving, from another network node associated with a candidate cell of the one or more candidate cells, an indication that a conditional handover procedure was performed between the UE 120 and the other network node, wherein the conditional handover procedure is triggered based at least in part on the height of the UE 120. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

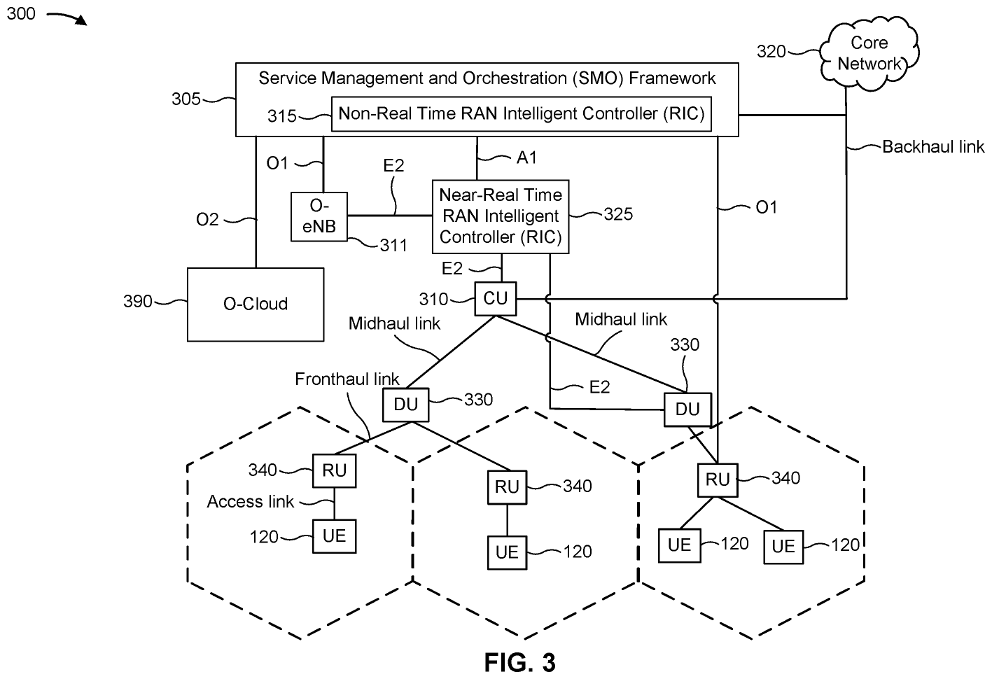

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

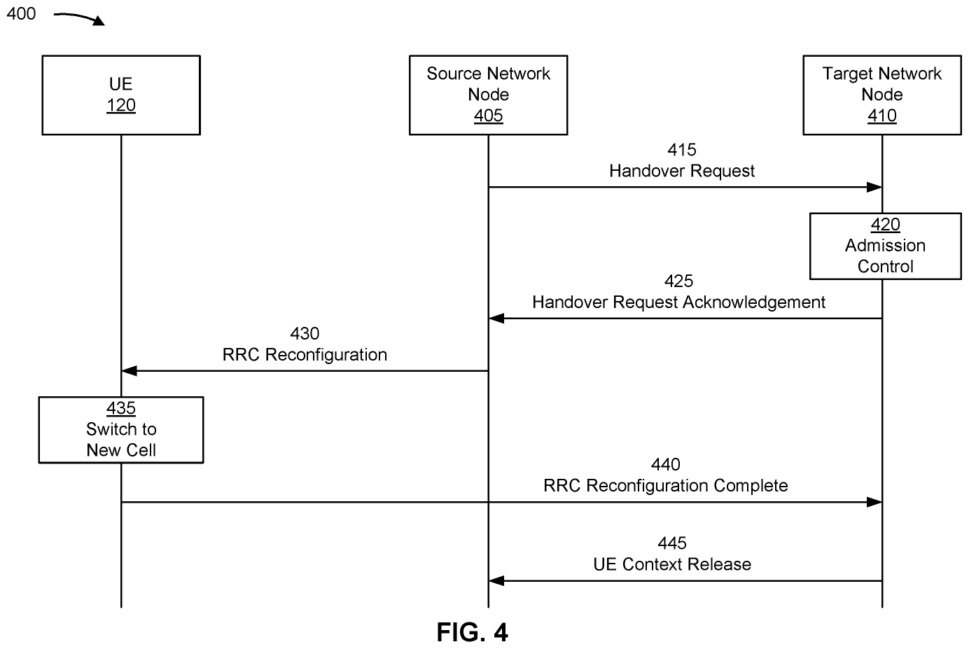

FIG. 4 is a diagram illustrating an example of a handover procedure 400, in accordance with the present disclosure.

The handover procedure may be performed by a UE 120, a source network node 405 (e.g., network node 110), and a target network node 410 (e.g., another network node 110). As used herein, “source network node” may refer to a network node associated with a serving cell or a network node with which the UE 120 currently has an active or established connection, such as an RRC connection in a connected or active state. “Target network node” may refer to a network node associated with a cell that is identified as a cell to replace a serving cell for a UE 120 (e.g., as part of a handover procedure). In some examples, the source network node 405 may be associated with a primary cell (PCell) or a special cell (SpCell) and the target network node 410 may be associated with a target cell to replace the source network node 405 as the PCell or the SpCell.

As shown in FIG. 4, and by reference number 415, the source network node 405 may initiate handover of the UE 120 to the target network node 410 by transmitting a handover request message to the target network node 410. The source network node 405 may transmit the handover request message to the target network node 410 over an Xn, X2, or a next generation application protocol (NGAP) interface, among other examples. As shown by reference number 420, the target network node 410 may perform admission control procedures associated with the handover based at least in part on receiving the handover request message. As shown by reference number 425, the target network node 410 may transmit a handover request acknowledgement message to the source network node 405 (e.g., if the admission control procedures indicate that the target network node 410 can accept the handover of the UE 120). The handover request acknowledgement message may include an RRC configuration for connection to the target network node 410.

As shown by reference number 430, the source network node 405 may transmit the RRC configuration to the UE 120 by transmitting an RRC reconfiguration message to the UE 120 that includes the RRC configuration of the handover request acknowledgement message. As shown by reference number 435, the UE 120 may switch to the new cell (e.g., the cell associated with the target network node 410) by changing an RRC connection from the source network node 405 to the target network node 410 based at least in part on the RRC reconfiguration. As shown by reference number 440, the UE 120 may transmit an RRC reconfiguration complete message to the target network node 410. The RRC reconfiguration complete message may indicate that the UE 120 has changed the RRC connection from the source network node 405 to the target network node 410. As shown by reference number 445, the target network node 410 may transmit a UE context release message to the source network node 405. The UE context release message may indicate that the handover of the UE 120 to the target network node 410 was successful.

In some examples, the UE 120 may be unable to successfully connect with the target network node 410. For example, the UE 120 may attempt to connect with the target network node 410 (e.g., by performing a random access channel (RACH) procedure with the target network node 410), but the attempt to connect with the target network node 410 may fail. If the UE 120 is unable to successfully connect with the target network node 410, then the UE 120 may perform a connection re-establishment procedure to re-establish a connection with the source network node 405 or another network node. For example, the UE 120 may transmit an RRC re-establishment request message to the network (e.g., to the source network node 405 or another network node).

Additionally, the UE 120 may reset a MAC entity of the UE 120, release the RRC configuration for the handover procedure, suspend all radio bearers (except a signaling radio bearer (SRB) indexed as SRB0, in some examples), release a connection with any configured secondary cells (SCells), or release all other configurations stored by the UE 120, among other examples. Therefore, the UE 120 may re-establish an RRC connection (e.g., with the source network node 405 or another network node) in the event that the handover procedure with the target network node 410 fails.

As indicated above, FIG. 4 is provided as an example. Other examples may differ from what is described with regard to FIG. 4.

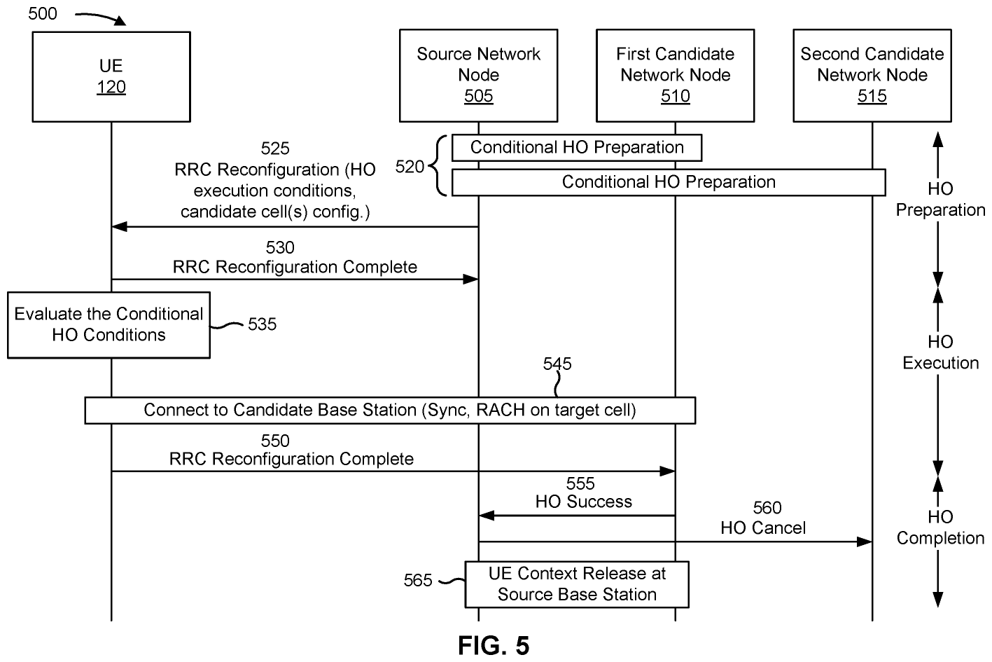

FIG. 5 is a diagram illustrating an example of a conditional handover procedure 500, in accordance with the present disclosure. Unlike the handover procedure described in connection with FIG. 4, for a conditional handover procedure, a UE (e.g., UE 120) may be pre-configured by a source network node with certain handover conditions, and then may trigger a handover procedure if certain of the handover conditions are met. This may beneficially reduce handover latency as compared to the handover procedure described in connection with FIG. 4.

More particularly, the conditional handover procedure 500 shown in FIG. 5 may be performed by a UE 120, a source network node 505 (e.g., a network node 110), and one or more candidate network nodes 510, 515 (e.g., other network nodes 110). As used herein, “candidate network node” may refer to a network node that is a candidate to serve as a target network node for the UE as part of a handover procedure. In some examples, the source network node 505 may be associated with a PCell or an SpCell and the candidate network nodes 510, 515 may be associated with a target cell to replace the source network node 505 as a PCell or SpCell.

As shown in FIG. 5, and by reference number 520, the source network node 505 may communicate with a first candidate network node 510 and a second candidate network node 515 to prepare the first and second candidate network nodes 510, 515 for a conditional handover of the UE 120. For example, the source network node 505 may transmit a handover request message to the first candidate network node 510 or the second candidate network node 515. The first candidate network node 510 or the second candidate network node 515 may transmit a handover request acknowledgement message to the source network node 505, as described above in connection with FIG. 4.

As shown by reference number 525, the source network node 505 may transmit an RRC reconfiguration message to the UE 120. The RRC reconfiguration message may include a conditional handover configuration (sometimes referred to as a conditionalReconfiguration parameter and/or included in a conditionalReconfiguration information element (IE)) that indicates configurations for the candidate network nodes 510, 515, that indicates one or more criteria or execution conditions (e.g., conditional thresholds) generated by the source network node 505 that trigger handover, or that indicates other information. In some instances, an execution condition may consist of one or two trigger conditions, such as one or two conditional events A3 and/or A5 (sometimes referred to as condEventA3 or condEventA5), described in more detail below in connection with reference number 535. In some cases, conditional events A3 and/or A5 are sometimes referred to as radio resource management (RRM) conditions. In some cases, the UE 120 may be configured with a single type of reference signal (e.g., a channel state information (CSI) reference signal (CSI-RS), a synchronization signal block (SSB), or the like) and up to two different trigger quantities (e.g., up to two of RSRP, RSRQ, signal-to-interference-plus-noise ratio (SINR), or the like) may be configured for simultaneous evaluation of conditional handover execution of a single candidate cell. As shown by reference number 530, the UE 120 may transmit an RRC reconfiguration complete message to the source network node 505, which may indicate that the UE 120 has applied the RRC reconfiguration (e.g., the conditional handover configuration).

As shown by reference number 535, the UE 120 may evaluate the conditional handover conditions and/or detect a conditional handover event for the first candidate network node 510. In some cases, the UE 120 may maintain a dynamic list of conditionalReconfiguration IEs, sometimes referred to as a varConditionalReconfig parameter or a varConditionalReconfig IE. Put another way, the UE 120 variable varConditionalReconfig may include the accumulated configuration of the conditional handover configurations. In some instances, the varConditionalReconfig may include multiple conditional reconfiguration identifiers (sometimes referred to as condReconfigId), with each conditional reconfiguration identifier corresponding to a candidate cell (e.g., a cell associated with the first candidate network node 510 or a cell associated with the second candidate network node 515). For each conditional reconfiguration identifier (e.g., for each condReconfigId), the UE 120 may be configured with up to two triggering events (sometimes referred to as condExecutionCond). The conditional reconfiguration event of the two triggering events (e.g., the two condExecutionCond parameters) may have the same or different event conditions, triggering quantities, times to trigger, triggering thresholds, or the like. The UE 120 may measure certain metrics (e.g., RSRP, RSRQ, SINR, or the like) and determine that the one or more criteria or execution conditions for triggering handover to the first candidate network node 510 are satisfied (e.g., a measurement associated with a signal transmitted by the first candidate network node 510 may satisfy a threshold or may be greater than (by a threshold amount) a measurement associated with a signal transmitted by the source network node 505).

For example, in some cases, the UE 120 may trigger a handover procedure if one of the cells associated with the candidate network nodes 510, 515 (sometimes referred to as a neighbor cell) becomes offset better than a serving cell (e.g., an SpCell), such as a cell associated with the source network node 505 (sometimes referred to as a conditional event A3, or condEventA3). Put another way, conditional event A3 provides a handover triggering mechanism based upon relative measurement results, such as when the RSRP, RSRQ, SINR, or similar measurement of a neighbor cell is stronger than a corresponding RSRP, RSRQ, SINR, or similar measurement of the SpCell. In some cases, a conditional event A3 handover to a neighbor cell may be triggered according to the condition Mn+Ofn+Ocn−Hys>Mp+Ofp+Ocp+Off (sometimes referred to as the trigger condition or entering condition), and handover to the neighbor cell may be cancelled if the condition Mn+Ofn+Ocn+Hys<Mp+Ofp+Ocp+Off (sometimes referred to as the cancellation condition or leaving condition) is satisfied within a certain time period of triggering handover (sometimes referred to as a time to trigger (TTT), or timeToTrigger). For such conditions, Mn is the measurement result of the neighboring cell (e.g., RSRP, RSRQ, SINR, or the like), Ofn is the measurement object specific offset of a reference signal of the neighbor cell, Ocn is the cell specific offset of the neighbor cell, Hys is the hysteresis parameter associated with the triggering event, Mp is the measurement result of the SpCell (e.g., RSRP, RSRQ, SINR, or the like), Ofp is the measurement object specific offset of the SpCell, Ocp is the cell specific offset of the SpCell, and Off is the offset parameter associated with the triggering event.

In some other cases, UE 120 may trigger a handover procedure if the cell associated with the source network node 505 (e.g., the SpCell) becomes worse than a first threshold value, and one of the cells associated with the candidate network nodes 510, 515 (e.g., one of the neighbor cells) becomes better than a second threshold value (sometimes referred to as a conditional event A5, or condEventA5). In some cases, a conditional event A5 handover to a neighbor cell may be triggered according to the conditions Mp+Hys<Thresh1 and Mn+Ofn+Ocn−Hys>Thresh2 (e.g., the trigger conditions or entering conditions), and handover to the neighbor cell may be cancelled if the conditions Mp−Hys>Thresh1 and Mn+Ofn+Ocn+Hys<Thresh2 (e.g., the cancellation conditions or leaving conditions) are satisfied within a TTT, where Thresh1 is a first threshold parameter and Thresh2 is a second threshold parameter.

Additionally, or alternatively, in some cases, a UE 120 may be configured with one or more events for transmitting a measurement report to a network node, such as to the source network node 505. For example, a UE 120 may be configured with measurement report events associated with a height of the UE 120 (e.g., an altitude of the UE 120, or, more particularly, a distance of the UE 120 above sea level, a distance of the UE 120 above land, a height of the UE 120 with respect to a reference height or altitude, or the like), sometimes referred to as an event H1 (or EventH1) and/or an event H2 (or EventH2). In such instances, the event H1 and/or the event H2 may be stored within a configured variable measurement list (sometimes referred to as a varMeasConfig list) and/or may be associated with a measurement identifier (e.g., measId). In such aspects, if one of the conditional event H1 and/or the conditional event H2 conditions is met (e.g., if the UE 120 satisfies a height threshold associated with one of the event H1 and/or the event H2), the UE 120 may transmit a measurement report to the source network node 505 indicating the UE 120's height, and the source network node 505 may reconfigure the conditional handover configurations accordingly, such as by repeating the handover preparation steps (e.g., the steps described in connection with reference numbers 520, 525, and 530) for different candidate cells. For example, a cell may perform differently with respect to a height of a UE 120, and thus if the UE 120 gains or loses enough height, which may be indicated to the source network entity via the measurement report, the source network node 505 may reconfigure the UE 120 to perform conditional handover measurements associated with different candidate cells, or the like.

In some cases, the UE 120 may detect a conditional handover event for more than one cell associated with a candidate network node (e.g., for both the cell associated with the first candidate network node 510 and the cell associated with the second candidate network node 515). In such cases, the UE 120 may select one of the triggered cells as a selected cell for conditional reconfiguration execution. For example, the UE 120 may select a cell based at least in part on a beam and/or beam quality associated with each triggered cell (e.g., the UE 120 may select a cell associated with a preferred beam and/or having a higher beam quality).

As shown by reference number 545, the UE 120 may change an RRC connection from the source network node 505 to the first candidate network node 510, as described above in connection with FIG. 4, based at least in part on detecting the conditional handover event or execution condition for the first candidate network node 510. That is, the UE 120 may execute the handover upon detecting the conditional handover event, and not wait for an RRC reconfiguration message from the source network node 505. Put another way, the UE 120 may apply the stored configuration corresponding to the selected candidate cell and synchronize to the candidate cell. This may reduce handover latency as compared to the handover procedure described in connection with FIG. 4.

As shown by reference number 550, the UE 120 may transmit an RRC reconfiguration complete message to the first candidate network node 510. The RRC reconfiguration complete message may indicate that the UE 120 has changed an RRC connection from the source network node 505 to the first candidate network node 510, as described above in connection with FIG. 4. As shown by reference number 555, the first candidate network node 510 may transmit a handover success message (e.g., indicating successful handover of the UE 120) to the source network node 505. As shown by reference number 560, the source network node 505 may transmit a handover cancel message to the second candidate network node 515. The handover cancel message may indicate that the second candidate network node 515 is to discard the handover request message (e.g., transmitted as described in connection with reference number 520). As shown by reference number 565, the source network node 505 and the first candidate network node 510 may perform a UE context release procedure to release the UE 120 context at the source network node 505.

In a similar manner as described above in connection with FIG. 4, the UE 120 may be unable to establish a connection with the first candidate network node 510. For example, the handover procedure with the first candidate network node 510 may fail. In some examples, the UE 120 may attempt to perform a RACH procedure with the first candidate network node 510, but the RACH procedure may be unsuccessful. In some examples, rather than releasing one or more (or all) RRC configurations at the UE 120 when the handover procedure with the first candidate network node 510 fails, the UE 120 may maintain the conditional handover configuration. This may enable the UE 120 to continue to search for or measure candidate network entities indicated by the conditional handover configuration. For example, the UE 120 may detect a conditional handover event for the second candidate network node 515. That is, the UE 120 may determine that the one or more criteria or execution condition(s) for triggering handover to the second candidate network node 515 are satisfied (e.g., after the handover attempt with the first candidate network node 510 fails). Because the UE 120 has not released the conditional handover configuration, the UE 120 may change an RRC connection from the source network node 505 to the second candidate network node 515, as described above in connection with FIG. 4, based at least in part on detecting the conditional handover event for the second candidate network node 515. That is, the UE 120 may execute the handover upon detecting that an execution condition is satisfied, and not wait for an RRC reconfiguration message from the source network node 505. Moreover, the UE 120 may not wait for an additional conditional handover reconfiguration after the handover attempt with the first candidate network node 510 fails. This may reduce handover latency associated with conditional handovers.

In some cases, a UE 120 may be an aerial UE or the like that changes height (e.g., altitude) frequently, thereby frequently triggering one or more handover or measurement events. For example, an aerial UE 120 may be configured with one or more of an event H1 condition or an event H2 condition, which may be repeatedly triggered as the UE 120 changes altitude. The UE 120 may thus frequently send the source network node 505 measurement reports associated with the event H1 and/or event H2 conditions, and thus source network node 505 may repeatedly reconfigure the UE 120 with different candidate cells based at least in part on a current height of the UE 120. This may result in high RRC-level signaling overhead, because the UE 120 may transmit numerous measurement reports to the source network node 505 and because the source network node 50 may in turn transmit numerous RRC reconfiguration messages to reconfigure the UE 120 with different candidate cells. This high RRC-level signaling overhead may result in congested communication channels and thus high latency, low throughput, and overall inefficient usage of network resources.

Some techniques and apparatuses described herein enable configuration of height-specific conditional handover conditions, thereby reducing RRC-level signaling overhead associated with an aerial UE 120 or the like that frequently changes height. In some aspects, a UE (e.g., UE 120) may receive a configuration of one or more conditional handover events associated with one or more candidate cells, with each of the one or more conditional handover events being based at least in part on a height of the UE. For example, the UE may receive a configuration of conditional RRM events (e.g., a conditional event A3, a conditional event A5, or the like) parametrized by a height event (e.g., event H1, event H2, or the like), the UE may receive a configuration of a conditional height event (sometimes referred to as a conditional event H1, a conditional event H2, or the like) that triggers a handover procedure rather than triggering a measurement report, and/or the UE may receive multiple height-specific configurations and thus may select an applicable conditional handover configuration based on the UE's current height. By receiving a configuration of one or more conditional handover events associated with one or more candidate cells, with each of the one or more conditional handover events based at least in part on a height of the UE, a UE may evaluate conditional handover conditions and/or may trigger a conditional handover procedure based at least in part on a current height of the UE without requiring back-and-forth RRC signaling between the UE and a source network node as the UE changes height. As a result, RRC-level signaling overhead may be reduced as compared to legacy conditional handover procedures, thereby resulting in less congested communication channels and thus lower latency, higher throughput, and overall more efficient usage of network resources.

As indicated above, FIG. 5 is provided as an example. Other examples may differ from what is described with regard to FIG. 5.

FIG. 6 is a diagram of an example 600 associated with conditional handover conditions associated with a height of a UE, in accordance with the present disclosure. As shown in FIG. 6, a UE 605 (e.g., UE 120) may communicate with one or more network nodes (e.g., one or more network nodes 110), such as a source network node 610 (e.g., source network node 505) and a candidate network node 615 (e.g., one of the first candidate network node 510 or the second candidate network node 515). In some aspects, the UE 605, the source network node 610, and the candidate network node 615 may be part of a wireless network (e.g., wireless network 100). The UE 605, the source network node 610, and the candidate network node 615 may have established a wireless connection prior to operations shown in FIG. 6. In some aspects, the UE 605, the source network node 610, and the candidate network node 615 may be associated with a conditional handover procedure, such as the conditional handover procedure described in connection with FIG. 5. In that regard, in some aspects, the UE 605 may have established an RRC connection with the source network node 610 prior to the operations shown and described in connection with FIG. 6.

As shown by reference number 620, the UE 605 may receive, from the source network node 610, configuration information. In some aspects, the UE 605 may receive the configuration information via one or more of RRC signaling, one or more MAC control elements (MAC-CEs), and/or downlink control information (DCI), among other examples. In some aspects, the configuration information may include an indication of one or more configuration parameters (e.g., already known to the UE 605 and/or previously indicated by the source network node 610 or other network device) for selection by the UE 605, and/or explicit configuration information for the UE 605 to use to configure the UE 605, among other examples. The UE 605 may configure itself based at least in part on the configuration information. In some aspects, the UE 605 may be configured to perform one or more operations described herein based at least in part on the configuration information.

In some aspects, the configuration information may include a configuration of one or more conditional handover conditions associated with one or more candidate cells. For example, the configuration information may include one or more conditionalReconfiguration IEs that indicate one or more execution conditions that trigger handover to each of the one or more candidate cells. Moreover, in some aspects, each of the one or more conditional handover conditions may be based at least in part on a height of the UE. Put another way, the UE 605 may be configured with multiple conditional handover conditions, each associated with a particular height or height range, such that if the UE 605 frequently changes height, the UE 605 may continue to evaluate conditional handover conditions without requiring back-and-forth RRC signaling with the source network node 610 (e.g., without requiring the UE 605 to transmit a measurement report to the source network node 610 and, in response, receive an updated configuration of one or more conditional handover conditions).

In some aspects, the configuration of the one or more conditional handover conditions may be further based at least in part on a measurement associated with the one or more candidate cells. For example, the UE 605 may be configured to measure an RSRP, an RSRQ, an SINR, or the like associated with the one or more candidate cells. In such aspects, a UE 120 may trigger a handover procedure to a candidate cell if both a measurement condition is satisfied and a height condition is satisfied, as described in more detail below in connection with reference number 630.

In some aspects, the one or more conditional handover conditions may include one or more RRM conditions (e.g., a conditional event A3, a conditional event A5, or the like) parameterized by one or more height conditions (e.g., an event H1, an event H2, or the like). For example, the one or more conditional handover conditions may include a conditional event A3 parameterized by one of an event H1 or an event H2, sometimes referred to as condEventA3H1 or condEventA3H2, respectively. In some aspects, a conditional event A3 parameterized by an event H1 or an event H2 (e.g., condEventA3H1 or condEventA3H2) may be triggered according to two entering conditions: Mn+Ofn+Ocn−Hys>Mp+Ofp+Ocp+Off (sometimes referred to as a first entering condition) and Ms−Hys>Thresh+Offset (sometimes referred to as a second entering condition), and a conditional event A3 parameterized by an event H1 or an event H2 may be cancelled if at least one of two leaving conditions occurs within a TTT: Mn+Ofn+Ocn+Hys<Mp+Ofp+Ocp+Off (sometimes referred to as a first leaving condition) or Ms+Hys<Thresh+Offset (sometimes referred to as a second leaving condition). For the first entering condition and the first leaving condition, Mn refers to the measurement result of the neighboring cell (e.g., RSRP, RSRQ, SINR, or the like), not taking into account any offsets; Ofn refers to the measurement object specific offset of a reference signal of the neighbor cell (sometimes referred to as offsetMO as defined within measObjectNR corresponding to the neighbor cell); Ocn refers to the cell specific offset of the neighbor cell (sometimes referred to as celllndividualOffset as defined within measObjectNR corresponding to the frequency of the neighbor cell); Hys refers to the hysteresis parameter associated with the triggering event (sometimes referred to as hysteresis as defined with reportConfigNR for the triggering event); Mp refers to the measurement result of the SpCell (e.g., RSRP, RSRQ, SINR, or the like), not taking into account any offsets; Ofp refers to the measurement object specific offset of the SpCell (sometimes referred to as offsetMO as defined within measObectNR corresponding to the SpCell); Ocp refers to the cell specific offset of the SpCell (sometimes referred to as celllndividualOffset as defined within measObjectNR corresponding to the SpCell), and is set to zero if not configured for the SpCell; and Offrefers to the offset parameter associated with the triggering event (sometimes referred to as a3-Offset as defined within reportConfigNR for the triggering event); where Mn and Mp are expressed in decibel-milliwatts (dBm) in the case of RSRP, or decibels (dB) in the case of RSRQ and SINR, and where Ofn, Ocn, Ofp, Ocp, Hys, and Off are expressed in dB. For the second entering condition and the second leaving condition, Ms refers to the height (e.g., altitude) of the UE 605, not taking into account any offsets; Hys refers to the hysteresis parameter associated with the triggering event (sometimes referred to as h1-hysteresis or h2-hysteresis as defined with reportConfigEUTRA for the triggering event); Thresh refers to the reference threshold parameter for the triggering event (sometimes referred to as heightThreshRef as defined within measConfig); and Offset refers to the offset value to the reference threshold parameter (e.g., heightThreshRej) to obtain the absolute threshold for the triggering event (sometimes referred to as h1-ThresholdOffset or h2-ThresholdOffset as defined within reportConfig); where Ms is expressed in a distance unit such as meters, and where Thresh is expressed in the same unit as Ms.

In some other aspects, the one or more conditional handover conditions may include a conditional event A5 parameterized by one of an event H1 or an event H2, sometimes referred to as condEventASH1 or condEventA5H2, respectively. In some aspects, a conditional event A5 parameterized by an event H1 or an event H2 (e.g., condEventASH1 or condEventA5H2) may be triggered according to three entering conditions: Mp+Hys<Thresh1 (sometimes referred to as a first entering condition), Mn+Ofn+Ocn−Hys>Thresh2 (sometimes referred to as a second entering condition), and Ms−Hys>Thresh+Offset (sometimes referred to as a third entering condition), and a conditional event A5 parameterized by an event H1 or an event H2 may be cancelled if at least one of three leaving conditions is satisfied within a TTT: Mp−Hys>Thresh1 (sometimes referred to as a first leaving condition), Mn+Ofn+Ocn+Hys<Thresh2 (sometimes referred to as a second leaving condition), and Ms+Hys<Thresh+Offset (sometimes referred to as a third leaving condition). For the above conditions, the variables refer to the same parameters as described above with respect to conditional event A3 parameterized by an event H1 or an event H2, with the addition of Thresh1 corresponding a first measurement threshold parameter and Thresh2 corresponding to a second measurement threshold parameter, which are expressed in dBm in the case of RSRP, or dB in the case of RSRQ and SINR.

In some aspects, the one or more conditional handover conditions may be associated with multiple TTTs (e.g., multiple timeToTrigger parameters). For example, in aspects in which the one or more conditional handover conditions include one or more RRM conditions (e.g., a conditional event A3, a conditional event A5, or the like) parameterized by one or more height conditions (e.g., an event H1, an event H2, or the like), the one or more RRM conditions may be associated with a first TTT, and the one or more height conditions may be associated with a second TTT different from the first TTT. In that regard, in order to trigger or cancel conditional handover, the RRM conditions (e.g., the first entering or leaving conditions associated with condEventA3H1 or condEventA3H2, or the first or second entering or leaving conditions associated with condEventASH1 or condEventA5H2) may need to be satisfied for a different time period than the height conditions (e.g., the second entering or leaving conditions associated with condEventA3H1 or condEventA3H2, or the third entering or leaving conditions associated with the condEventASH1 or condEventA5H2).

In some aspects, the one or more conditional handover conditions may be associated with one of a conditional event H1 (sometimes referred to as condEventH1) or a conditional event H2 (sometimes referred to as condEventH2). The conditional event H1 (e.g., condEventH1) and the conditional event H2 (e.g., condEventH2) may be similar to events H1 and H2 described above, except that, rather than triggering a measurement report containing the height of the UE 605 (as may be the case for event H1 and event H2), the conditional event H1 and the conditional event H2 may trigger a conditional handover procedure. Put another way, the conditional event H1 and the conditional event H2 may be associated with entering and leaving conditions for a conditional handover procedure, even without transmission of a measurement report to the source network node 610. Accordingly, when the UE 605 is configured with the conditional event H1 or the conditional event H2 for a particular cell, the UE 605 may trigger handover to the cell if the conditional event H1 or the conditional event H2 is satisfied, provided that any additional conditional events associated with the cell (e.g., conditional events A3 or A5, or the like) are also satisfied. For example, if a UE 605 is configured with an conditional event A3 and a conditional event H1 associated with a particular cell, the UE 605 may trigger handover to the cell when both the conditional event A3 and the conditional event H1 are satisfied.

Moreover, in some aspects, the configuration of the one or more conditional handover conditions may include a configuration of three or more conditional handover conditions associated with each candidate cell of the one or more candidate cells. Put another way, the condExecutionCond parameter may be configured to include a sequence length of greater than two. Accordingly, in some aspects, three or more conditional handover conditions may need to be satisfied for a given cell before a conditional handover procedure is triggered. For example, the configuration of the one or more conditional handover conditions may include, for a particular candidate cell, a configuration of an RRM conditional event (e.g., one of condEventA3 or condEventA5) based at least in part on one measurement type (e.g., one of an RSRP measurement, an RSRQ measurement, an SINR measurement, or the like), a configuration of another RRM conditional event (e.g., another of one of condEventA3 or condEventA5) based at least in part on another measurement type (e.g., another one of an RSRP measurement, an RSRQ measurement, an SINR measurement, or the like), and a configuration of one or more height conditional events (e.g., at least one of condEventH1 or condEventH2). In such aspects, in order to trigger the conditional handover procedure, the UE 605 may need to be within a certain height range or the like (as indicated by the configuration of one or more height conditional events associated with a particular cell) in addition to certain measurements associated with the particular cell satisfying trigger criteria.

In some aspects, the configuration information described in connection with reference number 620 may include multiple configurations. For example, in some aspects, the UE 605 may receive multiple configurations of one or more conditional handover conditions associated with the one or more candidate cells, with a first configuration, of the multiple configurations, being associated with a first height range of the UE 605, and with a second configuration, of the multiple configurations, being associated with a second height range of the UE 605. In some aspects, each configuration may include an indication of the corresponding height range. For example, in some aspects, a UE status configuration identifier parameter (sometimes referred to as a ueStatusConfigID parameter) associated with each configuration may be utilized to indicate a height range associated with the corresponding configuration. In some aspects, the UE 605 may be configured with multiple height variables (sometimes referred to as H1, H2, and so forth), and each configuration of one or more conditional handover conditions may correspond to a particular height range associated with the height variables. For example, a first configuration may apply when the UE 605 is within a first height interval, such as when the UE 605 is at a height less than H1, a second configuration may apply when the UE 605 is within a second height interval, such as when the UE 605 is at a height greater than H1 and less than H2, and so forth.

In some aspects, the configuration of the one or more conditional handover conditions associated with the one or more candidate cells may be based at least in part on a three-dimensional location of the UE 605. For example, a configuration of conditional handover conditions and/or a subset of conditional handover conditions may be associated with a given three-dimensional zone, such that the UE 605 may only monitor handover conditions applicable to a three-dimensional zone in which the UE 605 is currently located. Moreover, in some aspects, a configuration of conditional handover conditions and/or a subset of conditional handover conditions may be associated with different conditional triggers in addition to, or instead of, the RRM conditions (e.g., conditional event A3, conditional event A5, or the like) and/or the height conditions (e.g., event H1, event H2, conditional event H1, conditional event H2, or the like) described above. For example, in some aspects, the one or more conditional handover conditions may be further based at least in part on at least one of a timer and/or a time interval (sometimes referred to as condEventT1), a distance of the UE from a reference point (sometimes referred to as condEventD1), or the like. For example, in some aspects, the UE 605 may be configured to apply certain conditional handover conditions when the UE 605 is within a particular zone (sometimes referred to as geofencing) at a certain time in the day, or the like.

As shown by reference number 625, in some aspects, the UE 605 may evaluate the one or more conditional handover conditions. For example, the UE 605 may monitor the height of the UE 605 and/or measure certain reference signals (CSI-RSs, SSBs) to determine if one or more conditional handover conditions are satisfied. In this regard, the UE 605 may perform certain actions similar to those described in connection with reference number 535. Moreover, in some aspects, the UE 605 may select certain handover conditions to evaluate based at least in part on the height of the UE 605. For example, in aspects in which the UE 605 received multiple conditional handover configurations, with each conditional handover configuration associated with a different height range (as described above in connection with reference number 620), the UE 605 may select one of the first configuration or the second configuration based at least in part on the height of the UE 605.

As shown by reference number 630, in some aspects the UE 605 may trigger a conditional handover procedure based at least in part on the height of the UE 605. For example, the UE 605 may trigger a conditional handover procedure by connecting to the candidate network node 615 in response to one or more conditional handover conditions associated with the candidate network node 615 being satisfied. For example, in aspects in which the one or more conditional handover conditions include one or RRM conditions (e.g., one or more of conditional event A3, conditional event A5, or the like), parameterized by one or more height conditions (e.g., one or more of event H1, event H2, or the like), the UE 605 may trigger the conditional handover procedure based at least in part on a measurement associated with the one or more candidate cells satisfying one or more entering conditions associated with the RRM conditions, as well as the height of the UE 605 satisfying the one or more height conditions. Additionally, or alternatively, when the one or more conditional handover conditions are associated with one of a conditional event H1 or a conditional event H2, the UE 605 may trigger the conditional handover procedure based at least in part on the height of the UE satisfying the conditional event H1 or the conditional event H2. Additionally, or alternatively, when the UE 605 receives multiple configurations of one or more conditional handover conditions associated with the one or more candidate cells, the UE 605 may trigger a conditional handover procedure associated with a configuration corresponding to a current height of the UE 605.

Moreover, as described in connection with reference number 555, in some aspects, the candidate network node 615 may indicate to the source network node 610 that the UE 605 performed a conditional handover procedure with the candidate network node 615. More particularly, as shown by reference number 635, in some aspects the source network node 610 may receive, from another network node associated with a candidate cell of the one or more candidate cells (e.g., the candidate network node 615), an indication that a conditional handover procedure was performed between the UE 605 and the other network node. In this regard, the source network node 610 may perform the handover completion steps described in connection with FIG. 5, such as transmit handover cancellation messages to other candidate network nodes, as described above in connection with reference number 560, perform a UE context release procedure, as described above in connection with reference number 565, and/or perform similar actions.

Based at least in part on the UE 605 being configured with one or more conditional handover conditions that are based at least in part on a height of the UE 605, the UE 605 and/or one or more network nodes (e.g., the source network node 610, the candidate network node 615, and/or other candidate network nodes) may conserve computing, power, network, and/or communication resources that may have otherwise been consumed by RRC signaling as the UE 605 changed height. For example, based at least in part on the UE 605 being configured with one or more conditional handover conditions that are based at least in part on a height of the UE 605, the UE 605 and one or more network nodes may communicate with reduced RRC-level signaling overhead as compared to legacy conditional handover procedures, thereby resulting in less congested communication channels and thus lower latency, higher throughput, and overall more efficient usage of network resources.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 605) performs operations associated with conditional handover conditions associated with a height of a UE.

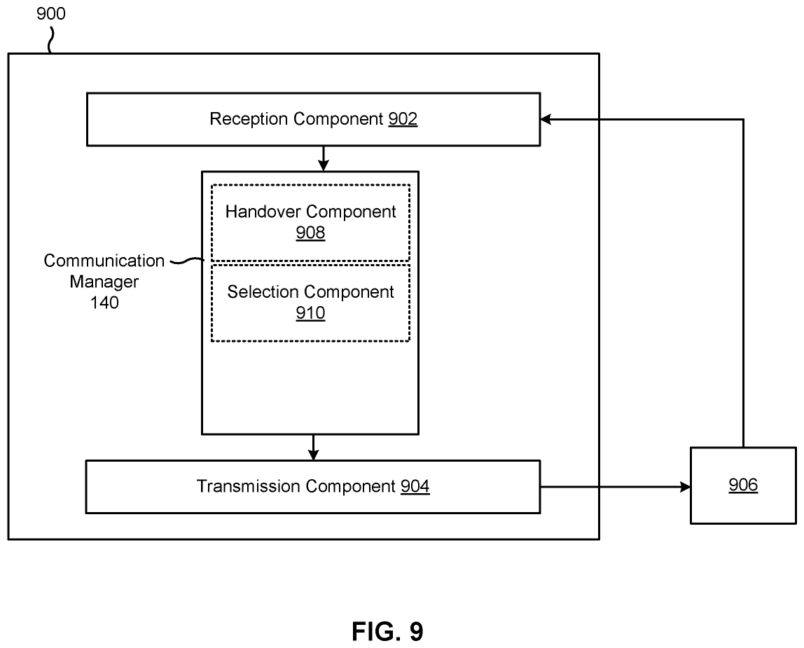

As shown in FIG. 7, in some aspects, process 700 may include receiving a configuration of one or more conditional handover conditions associated with one or more candidate cells, wherein each of the one or more conditional handover conditions is based at least in part on a height of the UE (block 710). For example, the UE (e.g., using communication manager 140 and/or reception component 902, depicted in FIG. 9) may receive a configuration of one or more conditional handover conditions associated with one or more candidate cells, wherein each of the one or more conditional handover conditions is based at least in part on a height of the UE, as described above.

As further shown in FIG. 7, in some aspects, process 700 may include triggering a conditional handover procedure based at least in part on the height of the UE (block 720). For example, the UE (e.g., using communication manager 140 and/or handover component 908, depicted in FIG. 9) may trigger a conditional handover procedure based at least in part on the height of the UE, as described above.

Process 700 may include additional aspects, such as any single aspect or any combination of aspects described below and/or in connection with one or more other processes described elsewhere herein.

In a first aspect, the configuration of the one or more conditional handover conditions is further based at least in part on a measurement associated with the one or more candidate cells, and triggering the conditional handover procedure is further based at least in part on the measurement associated with the one or more candidate cells.

In a second aspect, alone or in combination with the first aspect, the one or more conditional handover conditions include one or more RRM conditions parameterized by one or more height conditions.

In a third aspect, alone or in combination with one or more of the first and second aspects, the one or more RRM conditions are associated with at least one of a conditional event A3 or a conditional event A5.

In a fourth aspect, alone or in combination with one or more of the first through third aspects, the one or more conditional handover conditions are associated with one of a conditional event H1 or a conditional event H2.

In a fifth aspect, alone or in combination with one or more of the first through fourth aspects, the configuration of the one or more conditional handover conditions includes a configuration of three or more conditional handover conditions associated with each candidate cell of the one or more candidate cells.

In a sixth aspect, alone or in combination with one or more of the first through fifth aspects, process 700 includes receiving multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

In a seventh aspect, alone or in combination with one or more of the first through sixth aspects, process 700 includes selecting one of the first configuration or the second configuration based at least in part on the height of the UE.

In an eighth aspect, alone or in combination with one or more of the first through seventh aspects, the configuration of the one or more conditional handover conditions associated with the one or more candidate cells is further based at least in part on a three-dimensional location of the UE.

In a ninth aspect, alone or in combination with one or more of the first through eighth aspects, each of the one or more conditional handover conditions is further based at least in part on at least one of a measurement associated with a corresponding candidate cell of the one or more candidate cells, a time interval, or a distance of the UE from a reference point.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., source network node 610) performs operations associated with conditional handover conditions associated with a height of a UE.

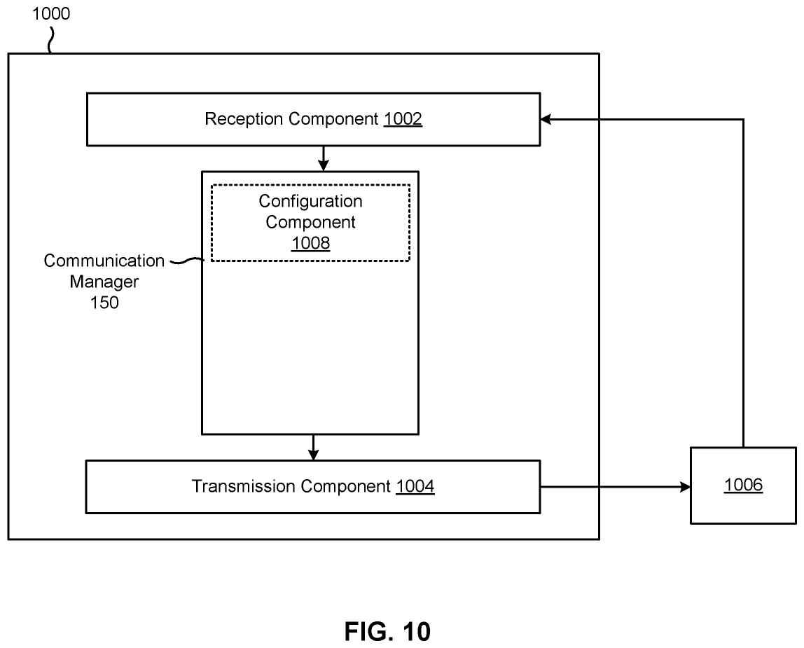

As shown in FIG. 8, in some aspects, process 800 may include transmitting, to a UE, a configuration of one or more conditional handover conditions associated with one or more candidate cells, wherein each of the one or more conditional handover conditions is based at least in part on a height of the UE (block 810). For example, the network node (e.g., using communication manager 150 and/or transmission component 1004, depicted in FIG. 10) may transmit, to a UE, a configuration of one or more conditional handover conditions associated with one or more candidate cells, wherein each of the one or more conditional handover conditions is based at least in part on a height of the UE, as described above.

As further shown in FIG. 8, in some aspects, process 800 may include receiving, from another network node associated with a candidate cell of the one or more candidate cells, an indication that a conditional handover procedure was performed between the UE and the other network node, wherein the conditional handover procedure is triggered based at least in part on the height of the UE (block 820). For example, the network node (e.g., using communication manager 150 and/or reception component 1002, depicted in FIG. 10) may receive, from another network node associated with a candidate cell of the one or more candidate cells, an indication that a conditional handover procedure was performed between the UE and the other network node, wherein the conditional handover procedure is triggered based at least in part on the height of the UE, as described above.

Process 800 may include additional aspects, such as any single aspect or any combination of aspects described below and/or in connection with one or more other processes described elsewhere herein.

In a first aspect, the configuration of the one or more conditional handover conditions is further based at least in part on a measurement associated with the one or more candidate cells.

In a second aspect, alone or in combination with the first aspect, the one or more conditional handover conditions include one or more RRM conditions parameterized by one or more height conditions.

In a third aspect, alone or in combination with one or more of the first and second aspects, the one or more RRM conditions are associated with at least one of a conditional event A3 or a conditional event A5.

In a fourth aspect, alone or in combination with one or more of the first through third aspects, the one or more conditional handover conditions are associated with one of a conditional event H1 or a conditional event H2.

In a fifth aspect, alone or in combination with one or more of the first through fourth aspects, the configuration of the one or more conditional handover conditions includes a configuration of three or more conditional handover conditions associated with each candidate cell of the one or more candidate cells.

In a sixth aspect, alone or in combination with one or more of the first through fifth aspects, process 800 includes transmitting, to the UE, multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

In a seventh aspect, alone or in combination with one or more of the first through sixth aspects, the configuration of the one or more conditional handover conditions associated with the one or more candidate cells is further based at least in part on a three-dimensional location of the UE.

In an eighth aspect, alone or in combination with one or more of the first through seventh aspects, each of the one or more conditional handover conditions are further based at least in part on at least one of a measurement associated with a corresponding candidate cell of the one or more candidate cells, a time interval, or a distance of the UE from a reference point.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., UE 605), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a handover component 908, or a selection component 910, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The reception component 902 and/or the handover component 908 may receive a configuration of one or more conditional handover conditions associated with one or more candidate cells, wherein each of the one or more conditional handover conditions is based at least in part on a height of the UE. The handover component 908 may trigger a conditional handover procedure based at least in part on the height of the UE.

The reception component 902 and/or the handover component 908 may receive multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE. The selection component 910 may select one of the first configuration or the second configuration based at least in part on the height of the UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node (e.g., source network node 610), or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a configuration component 1008, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node 110 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node 110 described in connection with FIG. 2. In some aspects, the transmission component 1004 may be co-located with the reception component 1002 in a transceiver.

The transmission component 1004 and/or the configuration component 1008 may transmit, to a UE, a configuration of one or more conditional handover conditions associated with one or more candidate cells, wherein each of the one or more conditional handover conditions is based at least in part on a height of the UE. The reception component 1002 may receive, from another network node associated with a candidate cell of the one or more candidate cells, an indication that a conditional handover procedure was performed between the UE and the other network node, wherein the conditional handover procedure is triggered based at least in part on the height of the UE.

The transmission component 1004 the configuration component 1008 may transmit, to the UE, multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving a configuration of one or more conditional handover conditions associated with one or more candidate cells, wherein each of the one or more conditional handover conditions is based at least in part on a height of the UE; and triggering a conditional handover procedure based at least in part on the height of the UE.

Aspect 2: The method of Aspect 1, wherein the configuration of the one or more conditional handover conditions is further based at least in part on a measurement associated with the one or more candidate cells, and wherein triggering the conditional handover procedure is further based at least in part on the measurement associated with the one or more candidate cells.

Aspect 3: The method of any of Aspects 1-2, wherein the one or more conditional handover conditions include one or more RRM conditions parameterized by one or more height conditions.

Aspect 4: The method of Aspect 3, wherein the one or more RRM conditions are associated with at least one of a conditional event A3 or a conditional event A5.

Aspect 5: The method of any of Aspects 1-4, wherein the one or more conditional handover conditions are associated with one of a conditional event H1 or a conditional event H2.

Aspect 6: The method of any of Aspects 1-5, wherein the configuration of the one or more conditional handover conditions includes a configuration of three or more conditional handover conditions associated with each candidate cell of the one or more candidate cells.

Aspect 7: The method of any of Aspects 1-6, further comprising receiving multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

Aspect 8: The method of Aspect 7, further comprising selecting one of the first configuration or the second configuration based at least in part on the height of the UE.

Aspect 9: The method of any of Aspects 1-8, wherein the configuration of the one or more conditional handover conditions associated with the one or more candidate cells is further based at least in part on a three-dimensional location of the UE.

Aspect 10: The method of any of Aspects 1-9, wherein each of the one or more conditional handover conditions is further based at least in part on at least one of: a measurement associated with a corresponding candidate cell of the one or more candidate cells, a time interval, or a distance of the UE from a reference point.

Aspect 11: A method of wireless communication performed by a network node, comprising: transmitting, to a UE, a configuration of one or more conditional handover conditions associated with one or more candidate cells, wherein each of the one or more conditional handover conditions is based at least in part on a height of the UE; and receiving, from another network node associated with a candidate cell of the one or more candidate cells, an indication that a conditional handover procedure was performed between the UE and the other network node, wherein the conditional handover procedure is triggered based at least in part on the height of the UE.

Aspect 12: The method of Aspect 11, wherein the configuration of the one or more conditional handover conditions is further based at least in part on a measurement associated with the one or more candidate cells.

Aspect 13: The method of any of Aspects 11-12, wherein the one or more conditional handover conditions include one or more RRM conditions parameterized by one or more height conditions.

Aspect 14: The method of Aspect 13, wherein the one or more RRM conditions are associated with at least one of a conditional event A3 or a conditional event A5.

Aspect 15: The method of any of Aspects 11-14, wherein the one or more conditional handover conditions are associated with one of a conditional event H1 or a conditional event H2.

Aspect 16: The method of any of Aspects 11-15, wherein the configuration of the one or more conditional handover conditions includes a configuration of three or more conditional handover conditions associated with each candidate cell of the one or more candidate cells.

Aspect 17: The method of any of Aspects 11-16, further comprising transmitting, to the UE, multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

Aspect 18: The method of any of Aspects 11-17, wherein the configuration of the one or more conditional handover conditions associated with the one or more candidate cells is further based at least in part on a three-dimensional location of the UE.

Aspect 19: The method of any of Aspects 11-18, wherein each of the one or more conditional handover conditions are further based at least in part on at least one of: a measurement associated with a corresponding candidate cell of the one or more candidate cells, a time interval, or a distance of the UE from a reference point.

Aspect 20: An apparatus for wireless communication at a device, comprising a processor; memory coupled with the processor; and instructions stored in the memory and executable by the processor to cause the apparatus to perform the method of one or more of Aspects 1-10.

Aspect 21: A device for wireless communication, comprising a memory and one or more processors coupled to the memory, the one or more processors configured to perform the method of one or more of Aspects 1-10.

Aspect 22: An apparatus for wireless communication, comprising at least one means for performing the method of one or more of Aspects 1-10.

Aspect 23: A non-transitory computer-readable medium storing code for wireless communication, the code comprising instructions executable by a processor to perform the method of one or more of Aspects 1-10.

Aspect 24: A non-transitory computer-readable medium storing a set of instructions for wireless communication, the set of instructions comprising one or more instructions that, when executed by one or more processors of a device, cause the device to perform the method of one or more of Aspects 1-10.

Aspect 25: An apparatus for wireless communication at a device, comprising a processor; memory coupled with the processor; and instructions stored in the memory and executable by the processor to cause the apparatus to perform the method of one or more of Aspects 11-19.

Aspect 26: A device for wireless communication, comprising a memory and one or more processors coupled to the memory, the one or more processors configured to perform the method of one or more of Aspects 11-19.

Aspect 27: An apparatus for wireless communication, comprising at least one means for performing the method of one or more of Aspects 11-19.

Aspect 28: A non-transitory computer-readable medium storing code for wireless communication, the code comprising instructions executable by a processor to perform the method of one or more of Aspects 11-19.

Aspect 29: A non-transitory computer-readable medium storing a set of instructions for wireless communication, the set of instructions comprising one or more instructions that, when executed by one or more processors of a device, cause the device to perform the method of one or more of Aspects 11-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration of one or more conditional handover conditions associated with one or more candidate cells, wherein each of the one or more conditional handover conditions is based at least in part on a height of the UE; and
trigger a conditional handover procedure based at least in part on the height of the UE.

2. The apparatus of claim 1, wherein the configuration of the one or more conditional handover conditions is further based at least in part on a measurement associated with the one or more candidate cells, and wherein triggering the conditional handover procedure is further based at least in part on the measurement associated with the one or more candidate cells.

3. The apparatus of claim 1, wherein the one or more conditional handover conditions include one or more radio resource management (RRM) conditions parameterized by one or more height conditions.

4. The apparatus of claim 3, wherein the one or more RRM conditions are associated with at least one of a conditional event A3 or a conditional event A5.

5. The apparatus of claim 1, wherein the one or more conditional handover conditions are associated with one of a conditional event H1 or a conditional event H2.

6. The apparatus of claim 1, wherein the configuration of the one or more conditional handover conditions includes a configuration of three or more conditional handover conditions associated with each candidate cell of the one or more candidate cells.

7. The apparatus of claim 1, wherein the one or more processors are further configured to receive multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

8. The apparatus of claim 7, wherein the one or more processors are further configured to select one of the first configuration or the second configuration based at least in part on the height of the UE.

9. The apparatus of claim 1, wherein the configuration of the one or more conditional handover conditions associated with the one or more candidate cells is further based at least in part on a three-dimensional location of the UE.

10. The apparatus of claim 1, wherein each of the one or more conditional handover conditions is further based at least in part on at least one of:
a measurement associated with a corresponding candidate cell of the one or more candidate cells,
a time interval, or
a distance of the UE from a reference point.

11. An apparatus for wireless communication at a network node, comprising:
a memory; and
one or more processors, coupled to the memory, configured to:
transmit, to a user equipment (UE), a configuration of one or more conditional handover conditions associated with one or more candidate cells, wherein each of the one or more conditional handover conditions is based at least in part on a height of the UE; and
receive, from another network node associated with a candidate cell of the one or more candidate cells, an indication that a conditional handover procedure was performed between the UE and the other network node, wherein the conditional handover procedure is triggered based at least in part on the height of the UE.

12. The apparatus of claim 11, wherein the configuration of the one or more conditional handover conditions is further based at least in part on a measurement associated with the one or more candidate cells.

13. The apparatus of claim 11, wherein the one or more conditional handover conditions include one or more radio resource management (RRM) conditions parameterized by one or more height conditions.

14. The apparatus of claim 13, wherein the one or more RRM conditions are associated with at least one of a conditional event A3 or a conditional event A5.

15. The apparatus of claim 11, wherein the one or more conditional handover conditions are associated with one of a conditional event H1 or a conditional event H2.

16. The apparatus of claim 11, wherein the configuration of the one or more conditional handover conditions includes a configuration of three or more conditional handover conditions associated with each candidate cell of the one or more candidate cells.

17. The apparatus of claim 11, wherein the one or more processors are further configured to transmit, to the UE, multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

18. The apparatus of claim 11, wherein the configuration of the one or more conditional handover conditions associated with the one or more candidate cells is further based at least in part on a three-dimensional location of the UE.

19. The apparatus of claim 11, wherein each of the one or more conditional handover conditions are further based at least in part on at least one of:
a measurement associated with a corresponding candidate cell of the one or more candidate cells,
a time interval, or
a distance of the UE from a reference point.

20. A method of wireless communication performed by a user equipment (UE), comprising:
receiving a configuration of one or more conditional handover conditions associated with one or more candidate cells, wherein each of the one or more conditional handover conditions is based at least in part on a height of the UE; and
triggering a conditional handover procedure based at least in part on the height of the UE.

21. The method of claim 20, wherein the one or more conditional handover conditions include one or more radio resource management (RRM) conditions parameterized by one or more height conditions.

22. The method of claim 20, wherein the one or more conditional handover conditions are associated with one of a conditional event H1 or a conditional event H2.

23. The method of claim 20, wherein the configuration of the one or more conditional handover conditions includes a configuration of three or more conditional handover conditions associated with each candidate cell of the one or more candidate cells.

24. The method of claim 20, further comprising receiving multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.

25. The method of claim 24, further comprising selecting one of the first configuration or the second configuration based at least in part on the height of the UE.

26. A method of wireless communication performed by a network node, comprising:
transmitting, to a user equipment (UE), a configuration of one or more conditional handover conditions associated with one or more candidate cells, wherein each of the one or more conditional handover conditions is based at least in part on a height of the UE; and
receiving, from another network node associated with a candidate cell of the one or more candidate cells, an indication that a conditional handover procedure was performed between the UE and the other network node, wherein the conditional handover procedure is triggered based at least in part on the height of the UE.

27. The method of claim 26, wherein the one or more conditional handover conditions include one or more radio resource management (RRM) conditions parameterized by one or more height conditions.

28. The method of claim 26, wherein the one or more conditional handover conditions are associated with one of a conditional event H1 or a conditional event H2.

29. The method of claim 26, wherein the configuration of the one or more conditional handover conditions includes a configuration of three or more conditional handover conditions associated with each candidate cell of the one or more candidate cells.

30. The method of claim 26, further comprising transmitting, to the UE, multiple configurations of one or more conditional handover conditions associated with the one or more candidate cells, wherein a first configuration, of the multiple configurations, is associated with a first height range of the UE, and wherein a second configuration, of the multiple configurations, is associated with a second height range of the UE.
